(19) United States
(12) Patent Application Publication
(10) Pub. No.: US 2026/0161414 A1
(43) Pub. Date: Jun. 11, 2026

(54) ISSUING CONSUMER INSTRUCTION

(71) Applicant: Arm Limited, Cambridge (GB)

(72) Inventor: Kim Richard SCHUTTENBERG, Gilbert, AZ (US)

(21) Appl. No.: 18/976,971

(22) Filed: Dec. 11, 2024

(51) Int. Cl. G06F 9/38

(52) U.S. Cl. CPC G06F 9/3836

(57) ABSTRACT

An apparatus comprises processing circuitry comprising execution units and issue circuitry to issue an instruction. In response to a consumer instruction identifying a source data operand, the issue circuitry identifies a set of one or more candidate producer instructions for the consumer instruction from a plurality of outstanding instructions that have not yet completed, each candidate producer instruction being capable of producing a data value to be used for the source data operand; and in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand, issues the consumer instruction to be executed.

### BACKGROUND

### Technical Field

The present technique relates to the field of data processing. In particular, the present technique relates to controlling when instructions are issued for execution.

### Technical Background

When executing a computer program, a sequence of instructions will be issued to processing circuitry to perform data processing operations corresponding to the instructions. Where an instruction uses a data value produced by an earlier instruction, a data dependency within the computer program can be identified. When issuing instructions to be executed by the processing circuitry, data dependencies can pose difficulties for issuing the instructions efficiently.

### SUMMARY

At least some examples of the present technique provide an apparatus comprising: processing circuitry comprising one or more execution units; and issue circuitry configured to issue an instruction to be executed by one of the one of more execution units; wherein in response to a consumer instruction identifying a source data operand, the issue circuitry is configured to: identify a set of one or more candidate producer instructions for the consumer instruction from a plurality of outstanding instructions that have not yet completed, wherein each candidate producer instruction is capable of producing a data value to be used for the source data operand of the consumer instruction; and in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issue the consumer instruction to be executed by one of the one or more execution units.

At least some examples of the present technique provide a system comprising: the apparatus described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a method comprising: issuing an instruction to be executed by one of one or more execution units; wherein in response to a consumer instruction identifying a source data operand: identifying a set of one or more candidate producer instructions for the consumer instruction from a plurality of outstanding instructions that have not yet completed, wherein each candidate producer instruction is capable of producing a data value to be used for the source data operand of the consumer instruction; and in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issuing the consumer instruction to be executed by one of the one or more execution units.

At least some examples of the present technique provide a non-transitory computer-readable medium storing computer-readable code for fabrication of an apparatus comprising: processing circuitry comprising one or more execution units; and issue circuitry configured to issue an instruction to be executed by one of the one of more execution units; wherein in response to a consumer instruction identifying a source data operand, the issue circuitry is configured to: identify a set of one or more candidate producer instructions for the consumer instruction from a plurality of outstanding instructions that have not yet completed, wherein each candidate producer instruction is capable of producing a data value to be used for the source data operand of the consumer instruction; and in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issue the consumer instruction to be executed by one of the one or more execution units.

Further aspects, features and advantages of the present technique will be apparent from the following description of examples, which is to be read in conjunction with the accompanying drawings.

### BRIEF DESCRIPTION OF THE DRAWINGS

FIG. 1 illustrates a data processing apparatus comprising issue circuitry, tracking circuitry and delay determination circuitry;

FIG. 2 illustrates an example stream of instructions from which a set of candidate producer instructions can be identified in respect of a consumer instruction;

FIG. 3 illustrates an example of tracking information;

FIG. 4 illustrates a sequence of steps for determining when to issue the consumer instruction;

FIG. 5 illustrates a sequence of steps for identifying a set of candidate producer instructions;

FIG. 6 illustrates a sequence of steps for determining a condition resolution delay associated with a candidate producer instruction;

FIG. 7 illustrates an example configuration of a plurality of execution units with data paths to bypass a register file;

FIG. 8 illustrates a system and a chip-containing product.

### DESCRIPTION OF EXAMPLES

In accordance with some example embodiments, there is provided an apparatus comprising processing circuitry comprising one or more execution units, and issue circuitry configured to issue an instruction to be executed by one of the one of more execution units. In a computer program, instructions may have data dependencies on older instructions, e.g. instructions that have appeared earlier in the program. A data dependency may be identified when an instruction (a consumer instruction) uses, for a source operand, a data value produced by an older instruction (producer instruction). In some scenarios, a consumer instruction may have multiple possible data dependencies, where there are multiple possible producer instructions that are capable of producing a data value to be used for the source data operand of the consumer instruction.

When the issue circuitry first encounters the consumer instruction for issuing, it may not be known which of the producer instructions will be the actual producer instruction that produces the data value to be used for the source operand. One approach could be to stall the consumer instruction and wait until only one possible producer instruction remains, however this negatively impacts the performance of the apparatus, e.g. due to the formation of pipeline bubbles causing execution units to be left idle for several cycles.

Hence, in accordance with the present techniques, the issue circuitry is responsive to a consumer instruction identifying a source data operand, to identify a set of one or more candidate producer instructions for the consumer instruction from among a plurality of outstanding instructions that have not yet been completed. A candidate producer instruction is identified due to being capable of producing a data value to be used for the source data operand of the consumer instruction. The issue circuitry can determine an appropriate time at which the consumer instruction can be issued, even in a case where the set of candidate producer instructions still comprises two or more candidate producer instructions. For example, the latest time at which the data value could be made available for use by the consumer instruction can be estimated. Therefore, the issue circuitry can, prior to determining which of the two or more candidate producer instructions is an actual producer instruction that will produce the data value to be used for the source data operand of the consumer instruction, issue the consumer instruction to be executed by one of the one or more execution units. Hence, the consumer instruction may be issued without having to be stalled until the only one candidate producer instruction remains in-flight, thereby reducing the occurrence of pipeline bubbles and improving performance.

In some examples, the issue circuitry may be configured to issue instructions “in-order”, such that younger instructions (e.g. that appear later in a program) are not permitted to bypass older instructions (e.g. that appear earlier in a program). It will be appreciated that where the processing circuitry has a plurality of execute slots (e.g. to enable superscalar processing), a younger instruction may be capable of being issued in parallel with, but not before, older instructions. Hence, where data dependencies exist, the consumer instruction may not be permitted to bypass any of the set of candidate producer instructions.

In some examples, the set of candidate producer instructions comprises at least one conditional instruction, where the one or more execution units then execute the conditional instruction in dependence on a respective condition being satisfied. Accordingly, some of the candidate producer instructions may end up not being the actual producer instruction which actually produces the data value to be used for the source data operand because they may not be executed at all, e.g. if the respective condition is not satisfied. The actual producer instruction may be one of the candidate producer instructions for which the respective condition is satisfied (since otherwise it would not produce a data value due to not being executed). Therefore, issuing the consumer instruction prior to determining which of the set of one or candidate producer instructions is the actual producer instruction may also be prior to determining whether the at least one conditional instruction will have a respective condition satisfied. By enabling a consumer instruction to be issued before the condition has been resolved for each earlier candidate producer instruction, performance can be improved.

In some examples, the apparatus comprises tracking circuitry to maintain tracking information associated with the instructions that are ‘in-flight’ (e.g. outstanding instructions that have not yet completed). The tracking circuitry is configured to store, for a given outstanding instruction, an indication of whether the given outstanding instruction is still capable of producing the data value to be used for the source data operand of the consumer instruction. For example, the indications may be maintained in the form of a vector with data elements corresponding to each outstanding instruction. Hence, an indication stored at a particular data element indicates whether that outstanding instruction is capable of producing the data value to be used as the source data operand of the consumer instruction. The indication may be, for example, a single bit where the bit being set to 1 indicates that the instruction is capable of producing the data value to be used for the source data operand of the consumer instruction, and the bit being set to 0 indicates that the instruction is not capable. Hence, in such an example, instructions that correspond with a bit set to 1 are included in the set of one or more candidate producer instructions described above.

In various examples, there may be several criteria for determining whether a given outstanding instruction is capable of producing the data value to be used for the source data operand of the consumer instruction.

In some examples, the tracking circuitry is configured to set the indication to indicate that the given outstanding instruction is not capable of being the actual producer instruction, in response to the given outstanding instruction specifying a destination register that is different to a source register specified by the consumer instruction. This criterion is indicative of whether the data dependency exists between the given outstanding instruction and the consumer instruction. If no such data dependency exists, then the given outstanding instruction cannot produce the data value to be used for the source data operand of the consumer instruction, and hence cannot be one of the candidate producer instructions.

In some examples, the tracking circuitry is configured to set the indication that the given outstanding instruction is not capable of being the actual producer instruction, in response to a younger instruction specifying a same destination register as the given outstanding instruction, wherein the younger instruction is an unconditional instruction or is a conditional instruction for which the respective condition is resolved as satisfied. In this example, it is identified that any data value produced by the given outstanding instruction would be overwritten by the younger instruction before the consumer instruction can use that data value for the source data operand. Therefore, the given outstanding instruction cannot be one of the candidate producer instructions.

In some examples, the tracking circuitry is configured to set the indication that the given outstanding instruction is not capable of being the actual producer instruction, in response to the given outstanding instruction being a conditional instruction for which the respective condition is resolved as unsatisfied. In such examples, it is identified that a conditional instruction that has a respective condition resolved as unsatisfied will not be executed by the execute units (or replaced with a no-operation). Hence, such an instruction will not produce a data value that can be used for the source data operand of the consumer instruction.

It will be appreciated that some examples may also apply any other criteria that is appropriate for the particular implementation. Based on such criteria, the tracking information can exclude instructions from the set of candidate producer instructions, thereby reducing any computation required for determining when to issue the consumer instruction.

In some examples, the tracking circuitry may store a plurality of instances of the tracking information, wherein each instance of the tracking information is associated with a corresponding register and is indicative of which outstanding instructions are capable of being the actual producer instruction for one of a plurality of source operands. It will be appreciated that the present techniques may be utilised for any consumer instruction specifying that corresponding register as source register. Hence, it will be appreciated that, a consumer instruction that uses plural source operands, or plural consumer instructions each using different source operands, may involve identifying a different set of candidate producer instructions for each source operand using a different instance of tracking information. This provides some additional functionality to identify a plurality of data dependencies and to simultaneously track different sets of candidate producer instructions for each data dependency.

In some examples, the tracking circuitry may maintain delay tracking information to indicate, for each of the at least one conditional instruction, a number of cycles until the respective condition can be resolved. Based on such delay tracking information, the issue circuitry may determine an appropriate time, prior to determining which of the set of candidate producer instructions is an actual producer instruction, at which the consumer instruction can be issued. This will be described in greater detail below.

For some conditional instructions, the respective condition may be resolved to be satisfied or not satisfied in dependence on a predicate value, where the predicate value is dependent on data generated by a predicate control instruction. Hence, where a candidate producer instruction is conditional, whether or not the candidate producer instruction is capable of being the actual producer instruction may be dependent on the execution of the predicate control instruction earlier in the program.

Some conditional instructions may be dependent on a predicate value that is dependent on data generated by two or more predicate control instructions. For example, a predicate value may be representative of multiple binary flags, which are set by different predicate control instructions. In some examples, the ability to track and predict whether the predicate value will cause the respective condition to be satisfied (and hence whether a conditional instruction is capable of being the actual producer instruction) becomes increasingly complex to the point that, in some implementations, the additional logic is not justified in relation to the improvement in performance of issuing the consumer instruction earlier. Hence, in some examples, in response to determining that the predicate value is dependent on data generated by two or more predicate control instructions, the issue circuitry is configured to suppress issuing the consumer instruction prior to determining which of the two or more candidate producer instructions is the actual producer instruction. Therefore, the consumer instructions may still be issued earlier on some occasions by using the present techniques (i.e. when the predicate value is dependent on one predicate control instruction), but without the excess hardware cost of predicting the timing at which a predicate becomes available when generated by multiple predicate control instructions.

In some examples, the apparatus comprises delay determination circuitry configured to determine a data availability delay indicative of a largest number of cycles until the data value to be used for the source data operand of the consumer instruction has been produced by each of the set of one or more candidate producer instructions. The data availability delay is therefore indicative of a maximum number of cycles until the actual producer instruction will be known or the latest that a candidate producer instruction will come to be the actual producer instruction. The issue circuitry may therefore use this information to issue the consumer instruction to be executed after the data availability delay. Hence, when the consumer instruction is executed, the data value will be available to be used as the source data operand. This permits the consumer instruction to be issued sooner, since the issue circuitry does not need to wait (i.e. by stalling the consumer instruction) until it is known which instruction is to be the actual producer instruction. This therefore allows the instructions to continue moving through the issue queue, thereby reducing the occurrence and/or duration of pipeline bubbles.

In some examples, the data availability delay is based on a condition resolution delay and a data production delay. The data production delay is a number of cycles for the one or more execution units to generate the data value in response to executing the given candidate producer instruction. This can be determined based on factors such as what type of instruction the given candidate producer instruction is, the timing at which an appropriate execution unit for that type of instruction may become available, availability of any source operands for the given candidate producer instruction, etc. The condition resolution delay is a number of cycles until a respective condition of a candidate producer instruction is resolved (i.e. as satisfied or not satisfied). This may be determined based on various information in dependence on how the respective condition is to be controlled.

In some examples, the respective condition may be dependent on control data produced by condition control instructions, e.g. the predicate control instructions described above. Hence, the delay determination circuitry may identify a set of such condition control instructions that are capable of producing control data resolving a respective condition of one of the set of candidate producer instructions. The condition resolution delay is then determined in dependence on the number of cycles until each of the set of condition control instructions will be completed. For example, if a condition control instruction is to compare two values and then set a condition flag if they are equal (say), then the condition resolution delay may be the number of cycles until that flag is set and can be used by later instructions.

When issuing the consumer instruction, the issue circuitry may select one of the execution units in an execution pipeline, where the consumer instruction progresses through the pipeline until it reaches the selected execution unit. Hence, the issue circuitry may issue the consumer instruction in dependence on the consumer instruction being able to reach an execution unit after the data availability delay. Conversely, if the data availability delay is a number of cycles larger than a number of cycles for the consumer instruction to reach any available execution unit of a type capable of executing the consumer instruction, the issue circuitry is configured to stall the consumer instruction.

In some examples, each of the set of one or more candidate producer instructions specifies a destination register that is a same register as a source register providing the source data operand of the consumer instruction.

In some examples, the processing circuitry comprises a plurality of execution units arranged in a plurality of pipeline stages, wherein the plurality of execution units includes at least two skewed execution units in different pipeline stages, each skewed execution unit configured to execute a same type of instruction. Skewed execution units permit an instruction to be executed at any of two or more different pipeline stages, to give more flexibility for adjusting the number of cycles between the time of issue and the time of execution. This can help eliminate pipeline bubbles, because it means there is more flexibility to issue an instruction in an available issue slot whose operand would not be available until deeper into the pipeline, whereas if the only available execution unit for that instruction was at an earlier stage then the instruction may have had to be stalled from being issued. This can then leave spare issue slots in later cycles to allow subsequent instructions to be issued earlier, reducing the likelihood of pipeline bubbles.

In some examples, the processing circuitry comprises bypassing circuitry configured to provide a data path to bypass a register file, wherein the data path is configured to make an output of one execution unit available as an input to a subsequent execution unit. Accordingly, if the consumer instruction is issued prior to determining which of the set of two or more candidate producer instructions will be the actual producer instruction, the data value produced by the actual producer instruction may be provided directly to an execution unit that is to execute the consumer instruction, without the additional latency of writing the data value to a register file, then retrieving the data value for use by the consumer instruction.

Specific examples are now described with reference to the drawings.

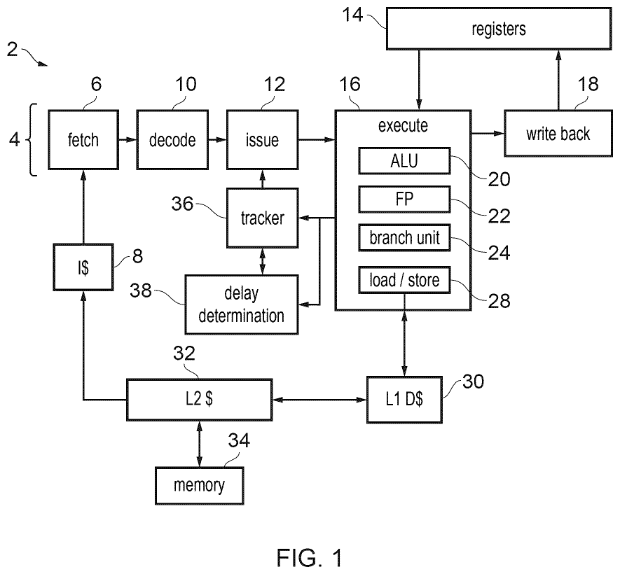

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and determining when to issue micro-operations for execution in dependence on when the required operands for a given micro-operation are available; an execute stage 16 for executing data processing operations corresponding to the micro-operations, by processing operands read from the register file 14 to generate result values; and a writeback stage 18 for writing the results of the processing back to the register file 14. The issue stage 12 is capable of identifying a consumer instruction, which is an instruction that may include a micro-operation that uses (or consumes) data that has been generated (or produced) by a preceding producer instruction. The issue stage 12 may therefore identify a predicted timing of when that operand will be available when determining when to issue the consumer instruction.

It will be appreciated that this is merely one example of possible pipeline architecture, and other systems may have additional stages or a different configuration of stages. In some examples, there may be a one-to-one relationship between program instructions decoded by the decode stage 10 and the corresponding micro-operations processed by the execute stage 16. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include an arithmetic/logic unit (ALU) 20 for performing arithmetic or logical operations; a floating-point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system include a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. For example, as discussed later, some of the processing units 20 to 28 may be implemented within two or more execution pipeline stages, with a plurality of processing units each configured to execute a same type of instruction being implemented at different pipeline stages (e.g. two ALUs arranged in different execution pipeline stages within the execute stage 16). It will be appreciated that FIG. 1 is merely a simplified representation of some components of a possible processor pipeline architecture, and the processor may include many other elements not illustrated for conciseness, such as branch prediction mechanisms or address translation or memory management mechanisms.

As the execute stage 16 performs processing operations in response to instructions issued by the issue stage 12, information regarding outstanding instructions that have not yet completed is provided back to the issue stage 12, for example via the tracker 36 and delay determination circuitry 38. The issue stage 12 may use such information, in response to receiving a consumer instruction, to identify a set of one or more candidate producer instructions from the outstanding instructions. A producer instruction may qualify as a candidate producer instruction if it is capable of producing a data value to be used for the source data operand of the consumer instruction. For example, candidate producer instructions may specify a destination register to which the produced data value is to be written, which is the same register as a source register specified by the consumer instruction. The tracker 36 may track, for a given source data register of the consumer instruction, which candidate producer instructions are still capable of being the actual producer instruction which will actually produce the data value to be used for the given source data register when executing the consumer instruction. Using this information, the issue stage 12 may more effectively determine when to issue the consumer instruction for execution by the execute stage 16. In particular, in a case where the set still comprises two or more candidate producer instructions each still capable of being the actual producer instruction, the issue circuitry may issue the consumer instruction prior to determining which of the two or more candidate producer instructions is an actual producer instruction that will produce the data value to be used for the source data operand of the consumer instruction. Hence, the consumer instruction may be issued (and hence executed) sooner than if the issue circuitry 12 were required to wait until it could be determined which producer instruction is the actual producer instruction.

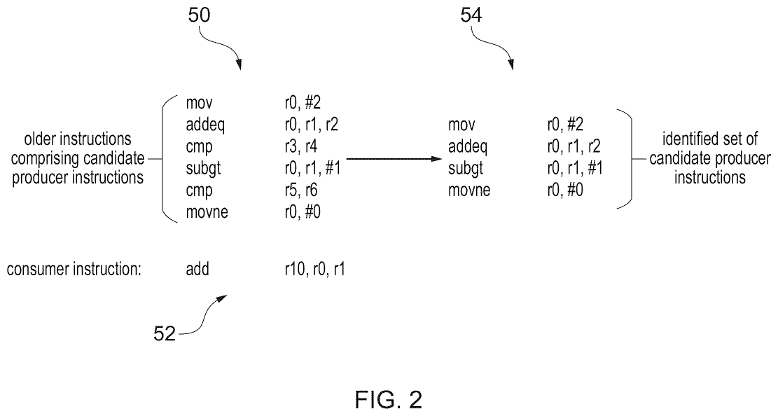

FIG. 2 illustrates an example stream of outstanding instructions 50, from which a set of candidate producer instructions may be identified. In this example, the issue stage 12 has received the consumer instruction 52, which is an add instruction to add the values in the source registers r0 and r1, and to write the result to the destination register r10. Therefore, the issue circuitry 12 may identify a data dependency between the consumer instruction 52 and preceding instructions that produce a data value for either of the registers r0 or r1. Such instructions may then be identified as among the set of candidate producer instructions 54.

The oldest instruction is a mov instruction, specifying the register r0 and an immediate value #2, which causes the value “2” to be written to the register r0.

In the stream of instructions 50, some of the instructions are conditional instructions, such that whether they are executed by the execute stage 16 is dependent on whether a respective condition is satisfied. For example, condition flags may be set in the execute stage 16 by preceding instructions and then checked when a conditional instruction is about to be executed. In the stream of instructions 50, an addeq instruction specifies the source registers r1 and r2 and writes the sum of those values to the destination register r0. The suffix “eq” indicates that the instruction is conditional on the condition flags indicating an “equal” indication (e.g. by a preceding comparison instruction identifying that two compared data values are equal). If the condition is not met, then the addeq instruction may be suppressed from being executed, e.g. by not being issued at all, or if already issued replaced with a no-operation (NOP).

Next, a cmp (compare) instruction is received, which compares the data values in the registers r3 and r4. The cmp instruction may set various condition flags in the execute stage 16, for example indicating one of the following conditions: greater-than (gt), less-than (lt), equal (eq), not-equal (ne), etc.

Next, a subgt or conditional subtract instruction is received, which subtracts the immediate value #1 from the value in the source register r1, and writes the result to destination register r0. The suffix “gt” indicates that the instruction is conditional on the condition flags indicating a “greater-than” indication. Hence, the subgt instruction is executed in dependence on whether the data value of r3 is greater than the data value of r4 (i.e. as determined by the preceding cmp instruction).

Next, another cmp instruction is received, which compares the data values in the registers r5 and r6, and sets various condition flags based on the result.

Next, a movne instruction is received specifying the register r0 and an immediate #0, which causes the value “0” to be written to the register r0. The suffix “ne” indicates that the instruction is conditional on the condition flags indicating a “not-equal” indication. Hence, the movne instruction is executed in dependence on whether the data value of r5 is not equal to r6 (i.e. as determined by the preceding cmp instruction).

From the above information of the sequence of instructions 50, it is possible to identify the set of candidate producer instructions 54 that are capable of writing producing a data value to be used for the source data operand of the consumer instruction. Initially, any instruction where a data dependency can be identified may be identified as part of the set of candidate producer instructions 54. For example, the instructions which cause data to be written to the register r0 (i.e. one of the source registers of the consumer instruction 52), may be identified as part of the set of candidate producer instructions 54. In this example, the set 54 therefore includes the mov, addeq, subgt, and movne instructions.

Since each of these instructions are still outstanding (i.e. not yet completed), it is not necessarily known which of the set 54, if any, will have their respective conditions resolved as satisfied. Hence, it is not known which of the set 54 is the actual producer instruction that produces the data to be used for the source data operand of the consumer instruction 52.

The set of candidate producer instructions 54 may be further refined in a number of ways. For example, the condition flags on which the addeq instruction may have already been set, e.g. by an older cmp instruction that has completed. Therefore, it may already be known that the condition flags do not indicate an “equal” indication, and hence the addeq instruction has its respective condition resolved as unsatisfied. As a result, the addeq instruction will not be executed (e.g. replaced with a NOP) and hence cannot be the actual producer instruction. The addeq instruction may therefore be excluded from the set of candidate producer instructions. By contrast, the respective condition for each of the subgt and movne instructions are not yet known, because there are older cmp instructions outstanding that might change the condition flags. Therefore, both instructions could still be capable of being the actual producer instruction.

Another way of refining the set of candidate producer instructions 54 is by monitoring when an instruction is unconditional or has a respective condition resolved as satisfied. For example, since the mov instruction is unconditional, the data value produced by any older producer instruction would be overwritten. Therefore, the data value produced by those older producer instructions cannot be used as the source data operand for the consumer instruction 52. Accordingly, those instructions are excluded from the set of candidate producer instructions 54.

It will be appreciated that the above sequence of instructions and their conditions are just one example, and other conditions may also be used. For example, in addition or as an alternative to condition flags, some instructions (e.g. predicate control instructions) may be used to control a predicate value comprising a set of bits. Micro-operations may then be performed or not performed in dependence on the predicate value. The process in FIG. 2 may still operate in a similar way, with the instructions that are conditional on the predicate value potentially potential candidate producer instructions that may be included in the set 54.

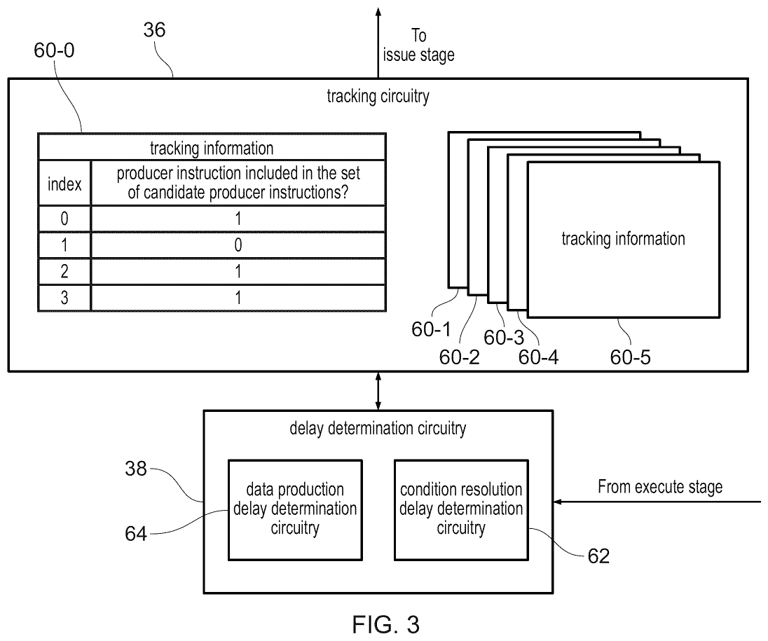

FIG. 3 illustrates an example of the tracking circuitry 36 (corresponding to the tracker 36 of FIG. 1). The tracking circuitry 36 maintains tracking information 60 in respect of the sequence of instructions 50 described above. Each entry of the tracking information 60-0 corresponds to one of the producer instructions in the outstanding instructions, and indicates whether each producer instruction is to be included in the set of candidate producer instructions 54. In this example, the mov, subgt and movne instructions (corresponding to indices 0, 2 and 3 respectively) are indicated as being capable of being the actual producer instruction. The addeq instruction (corresponding to index 1) are indicated as not being capable of being the actual producer instruction, e.g. due to the respective condition being resolved as unsatisfied.

The index of each entry in the tracking information 60-0 may be used in various ways to identify which instruction the entry relates to. For example, in the case of an execution pipeline, the indices may be indicative of pipeline slots at which each outstanding instruction is located. Alternatively, each of the outstanding instructions may be associated with an instruction ID, which then corresponds to an index of the tracking circuitry 60-0.

The tracking circuitry 36 may maintain a plurality of instances of tracking information 60-0 to 60-5, where each instance is associated with a corresponding register in the register file 14. It will be appreciated that the description in relation to FIG. 2 was focused on an actual producer for the data value in register r0, but the same process may also be performed in respect of an actual producer for the data value in register r1. There may be a separate set of candidate producer instructions that are capable of producing a data value to be written to the source register r1, where that set of candidate producer instructions are tracked using another instance of tracking information 60-1. Furthermore, tracking information 60-2 to 60-5 may include other sets of candidate producer instructions capable of producing data values to be written to other registers.

In some examples, the tracking information 60-0 may be incorporated into a data dependency matrix, which indicates where data dependencies exist between instructions. In particular, where an outstanding instruction is identified as not being among the set of candidate producer instructions, then the dependency matrix may be updated to indicate that no data dependency exists between that instruction and the consumer instruction. On the other hand, where an outstanding instruction is identified as being among the set of candidate producer instructions, the dependency matrix may be updated to indicate that a data dependency does exist between that instruction and the consumer instruction.

Also shown in FIG. 3 is the delay determination circuitry 38 which determines a data availability delay indicative of a largest number of cycles until the data value to be used for the source data operand of the consumer instruction has been produced by the set of candidate produce instructions. The data availability delay therefore indicates the latest point at which the source data operand will be available. The data availability delay is calculated based on a conditional resolution delay and a data production delay, which may be independently computed using condition resolution delay determination circuitry 62 and data production delay determination circuitry 64. It will be appreciated that it is not necessary to compute the data availability delay for every one of the set of candidate producer instructions. In some examples, it can be inferred that the data value produced by one instruction will be available sooner than another instruction. Using the sequence of instructions 50 of FIG. 2 as an example, the mov instruction would be expected to produce a data value sooner than the movne instruction, due to their respective positions in the sequence. Hence, the number of cycles until the data value from the movne instruction is available will be larger.

The data production delay is indicative of the number of cycles for the processing circuitry to generate the data value in response to executing a candidate producer instruction. This may be dependent on the type of instruction that is being executed. For example, for integer addition instructions, the ALU 20 may produce the data value in a single cycle, whereas for floating-point addition instructions, the floating-point unit 22 may produce the data value in 4 cycles. The data production delay determination circuitry 64 therefore may therefore evaluate the type of each candidate producer instruction to identify how long it will take for the data value to be produced in response to that candidate producer instruction being executed. The data production delay may also be representative of the delay in retrieving the source operands for the candidate producer instruction, and/or the delay for the candidate producer instruction to reach an available execution unit of a type capable of executing the candidate producer instruction.

The condition resolution delay is indicative of the number of cycles for until a respective condition of a candidate producer instruction is resolved. This may be determined based on identifying a set of condition control instructions, such as the cmp instructions shown in FIG. 2. The condition resolution delay may then be determined in dependence on a number of cycles until each of the set of condition control instructions will be completed. Using the sequence of instructions 50 of FIG. 2 as an example, the cmp instruction may be determined to be completed in 3 cycles and 5 cycles respectively. Since the delay determination circuitry 38 is to determine the largest number of cycles until the data value has been produced, the delay determination circuitry 38 may determine the data availability delay based on the longer of the two condition resolution delays.

Some conditional instructions may have their respective condition be dependent on multiple instructions. For example, instead of a condition being resolved by executing a single cmp instruction, a condition may be dependent on a predicate value having a particular value. That predicate value may be updated by one or more predicate control instructions. The predicate value may then be compared against the value that is required for the condition to be satisfied, and then the conditional instruction may be executed in dependence on whether the “equal” flag has been set.

The condition resolution delay may be determined for such predication conditions by tracking the predicate control instructions in the same way as tracking the condition control instructions described above. If a respective condition of one candidate producer instruction is dependent on a predicate value generated by two or more predicate control instructions, such tracking may require duplicated tracking circuitry for each predicate control instruction. In some implementations the additional hardware costs associated is not worth the performance improvement of issuing the consumer instruction sooner. Hence, in some examples, if it is determined that the predicate value is generated by two or more predicate control instructions, the issue circuitry suppresses issuing the consumer instruction early. Instead, the consumer instruction may be stalled in the issue queue until the actual producer instruction is known.

In some examples, the tracking circuitry may include an additional field to record the data availability delay of each candidate producer instruction, or an additional storage location to track the longest delay among the current set of candidate producer instructions. The tracking circuitry 36 may then control the issue stage 12 to issue the consumer instruction to be executed by the execute stage 16 after the data availability delay. Accordingly, the consumer instruction may be issued, even in a case where there are several candidate producer instructions still outstanding. By determining the data availability delay using the delay determination circuitry 38, it is known that the source data operand will be available for the consumer instruction when it is executed. Therefore, the consumer instruction can be issued sooner, thereby reducing the duration of instructions being held in the issue queue, while still ensuring compliance with data dependencies between instructions.

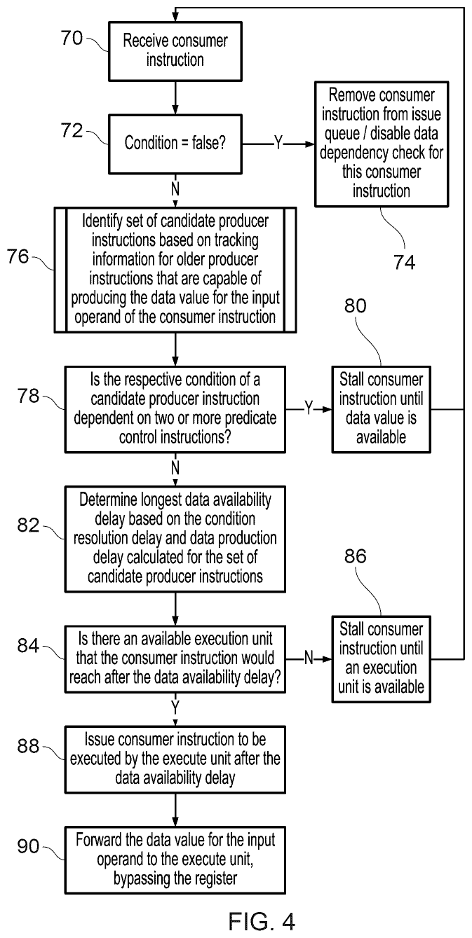

FIG. 4 illustrates a sequence of steps which may be performed by the issue stage 12 in accordance with the present techniques. The process begins at step 70, where a consumer instruction is received, thereby commencing the determination of when the consumer instruction is to be issued. At step 72, it is determined whether the consumer instruction is conditional, and if so, whether the respective condition has already been resolved as unsatisfied (i.e. condition=false). If so, then at step 74, the consumer instruction may be removed from the issue queue altogether and/or the data dependency tracking can be disabled for this consumer instruction.

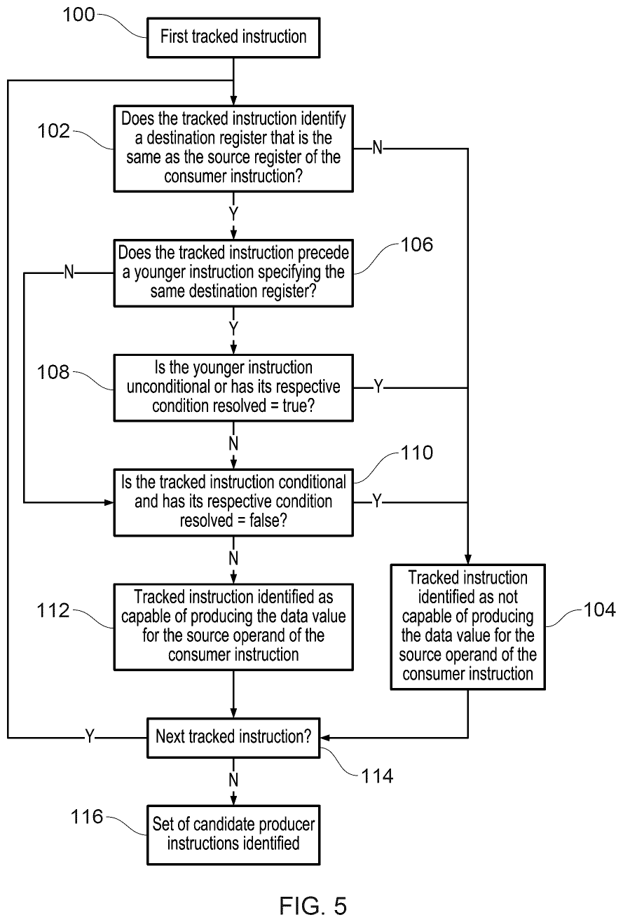

At step 76, the set of candidate producer instructions are identified based on the tracking information for older producer instructions that are capable of producing the data value for the input operand of the consumer instruction. The process of identifying the set of candidate producer instructions may be performed separately to the process of FIG. 4, such that the tracking information is already prepared and up-to-date to the current point of execution. Therefore, the issue stage 12 may only refer to the tracking information that is already available instead of performing the identification to cause the tracking information to be generated. The sub-process of step 76 will be described in further detail later with reference to FIG. 5.

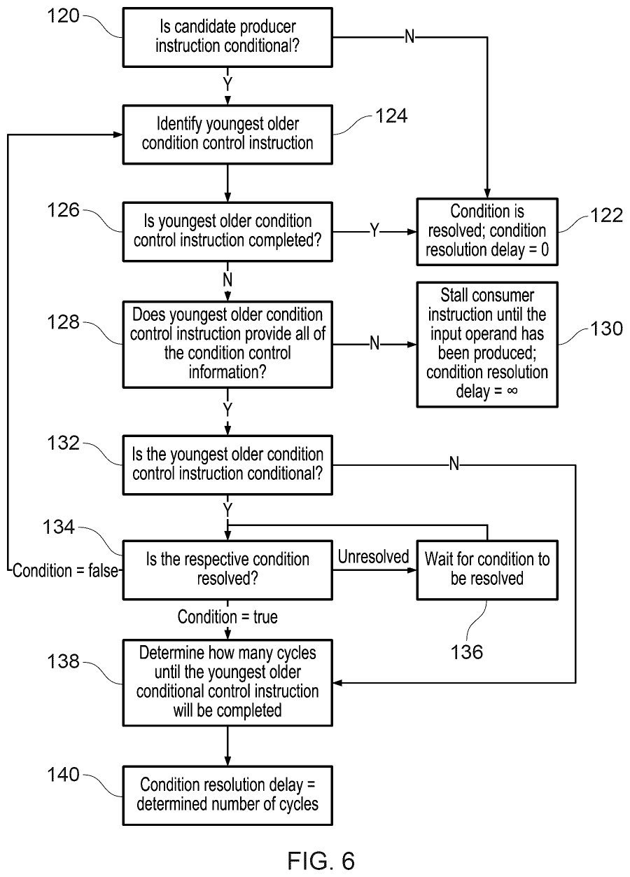

At step 78, it is determined whether the respective condition of a candidate producer instruction is dependent on two or more predicate control instructions. FIG. 4 represents an example implementation where the additional hardware cost of tracking two or more predicate control instructions has been excluded, e.g. for the reasons described above. Therefore, if the respective condition is dependent on two or more predicate control instructions, at step 80, the consumer instruction is stalled until the data value is available, e.g. when the actual producer instruction is known. If the respective condition of the candidate producer instruction is not dependent on two or more predicate control instructions, i.e. the condition is dependent on one instruction or is unconditional, the process continues to step 82. At step 82, the longest data availability delay is determined based on the condition resolution delay and the data production delay that are calculated for the set of candidate producer instructions. Further detail on how this process is performed will be discussed later with reference to FIG. 6.

At step 84, it is determined whether there is an available execution unit of a type that is capable of executing the consumer instruction, that can execute the consumer instruction after the data availability delay. For example, if the execute stage 16 is arranged in a plurality of pipeline stages, with at least two execution units in different pipeline stages, it is determined whether the consumer instruction, if issued now, would reach the end of the pipeline stages within the data availability delay. If so, then there is not an available execution unit, and the consumer instruction is stalled at step 86. However, if there is an available execution unit, then at step 88, the issue stage 12 issues the consumer instruction to be executed by the execute unit after the data availability delay. It will be appreciated that step 88 can occur prior to determining which of the candidate producer instructions is the actual producer instruction that will produce the data value to be used for the source data operand of the consumer instruction (at least on some occasions—on other occasions it may be that there is only one candidate producer instruction remaining by the time an available execution unit is ready).

Step 90 occurs when the consumer instruction is about to be executed by the execute stage 16. At this point, the actual producer instruction will have produced the data value to be used for the source data operand. The execute unit that executed the actual producer instruction may forward the data value directly to the execute unit that is to execute the consumer instruction using a bypass data path. Accordingly, the consumer instruction may make use of the data value without having to retrieve the data value from the register file 14, thereby allowing the consumer instruction to be executed immediately after the actual producer instruction.

Using the above process, the issue stage 12 is capable of issuing the consumer instruction prior to determining which of the candidate producer instructions is the actual producer instruction. Accordingly, performance can be improved by reducing the likelihood of a stall occurring in the issue queue.

FIG. 5 illustrates a sequence of steps which may be performed by the tracking circuitry 36 for maintaining the tracking information associated with outstanding instructions. This process may be performed continuously or periodically to update the tracking information as instructions are issued and completed.

The process begins with a first instruction that is to be tracked at step 100. At step 102, it is determined whether the tracked instruction identifies a destination register that is the same as the source register of a consumer instruction. It will be appreciated that this does not require a consumer instruction to actually be received, but rather that the identified destination register is a register that could be used as a source register of a consumer instruction that could be received during the sequence of instructions. As described above, the tracking circuitry 36 may maintain a plurality of instances of tracking information associated with different registers. Hence, step 102 may simply determine whether the destination register is the register associated with the tracking information.

If the tracked instruction does not identify a destination register that is the same as a source register of a consumer instruction (e.g. because the instruction either specifies a different destination register or does not produce data at all), then the tracked instruction is not capable of producing the data value for the source operand of the consumer instruction. At step 104, the tracked instruction is identified in the tracking information as not being a candidate producer instruction for the source operand.

If the tracked instruction does identify a destination register that is the same as a source register of a consumer instruction, that at step 106, it is determined whether the tracked instruction precedes a younger instruction specifying the same destination register. If so, then at step 108, it is determined whether the younger instruction is unconditional or has its respective condition resolved as satisfied (i.e. condition =true). If so, then any data produced by the tracked instruction will be overwritten by the younger instruction before a consumer instruction is executed. Accordingly, the tracked instruction is not capable of producing the data value for the source operand of the consumer instruction. At step 104, the tracked instruction is identified in the tracking information as not being a candidate producer instruction for the source operand.

At step 110, it is determined whether the tracked instruction has its respective condition resolved as unsatisfied (i.e. condition=false). If so, then the tracked instruction will not be executed (or replaced with a NOP), and hence will not be capable of producing the data value for the source operand of the consumer instruction. At step 104, the tracked instruction is identified in the tracking information as not being a candidate producer instruction for the source operand.

If the tracked instruction specifies a destination register matching the source register for which the tracking information is maintained, has no younger instruction which specifies the same destination register and has its condition resolved as true, and has its own condition still unresolved or already resolved as true, then at step 112, it is determined that the tracked instruction is capable of producing the data value for the source operand of the consumer instruction. The tracked instruction may therefore be identified in the tracked information as remaining a candidate producer instruction. Once the tracked instruction has been identified in the tracking information, i.e. in either of steps 104 or 112, the process may repeat with a new tracked instruction identified in step 114.

If there are no further tracked instructions (i.e. an entry of tracking information relates to each outstanding instruction), then it can be concluded that the set of candidate producer instructions has been identified at step 116. This set of candidate producer instructions can then be used by the issue stage 12, e.g. in step 76 of FIG. 4.

While FIG. 5 shows a sequential series of steps performed for a single instruction, in practice the corresponding updates to the tracking information could be performed in any order, e.g. at timings dependent on signals indicating events occurring for particular instructions as their conditions are resolved. Hence, it is not essential to follow the steps in the exact order shown in FIG. 5.

FIG. 6 illustrates a sequence of steps which may be performed by the delay determination circuitry 38 for determining the data availability delay for the set of candidate producer instruction. In particular, FIG. 6 illustrates the step for determining the condition resolution delay of a particular candidate producer instruction, based on which the data availability delay can be determined.

At step 120, it is determined whether the candidate producer instruction is conditional or not. If not (i.e. the candidate producer instruction is unconditional), then there is no condition to be resolved. Hence at step 122, the condition resolution delay is determined to be zero.

At step 124, the youngest older condition control instruction is identified. This may be, for example, a cmp instruction to set one or more condition flags which appears before the candidate producer instruction in the sequence of instructions currently being executed. At step 126, it is determined whether the youngest older condition control instruction has already been completed. If it has, then the condition has already been resolved, and the condition resolution delay is determined to be zero at step 122.

If the youngest older condition control instruction is still outstanding, then it is determined whether it provides all of the condition control information to resolve the condition at step 128. For example, as discussed above, some conditions may be dependent on data generated by two or more condition control instructions (e.g. a predicate value generated by predicate control instructions). If so, then as described in previous examples, a consumer instruction may be stalled instead of tracking each of the condition control instructions. Accordingly, at step 130, the condition resolution delay may be indicated e.g. as infinity or the largest value of the condition resolution delay that can be indicated. The effect of this is that the data availability delay is determined to be so large that the issue stage 12 cannot identify an available execution unit that the consumer instruction can reach after the data availability delay, thereby causing the consumer instruction to be stalled until the actual producer instruction is known (i.e. at steps 84 and 86 of FIG. 4).

If the youngest older condition control instruction provides all of the condition control information, such that the condition can be resolved with data generated by one instruction, then at step 132, it is further determined whether the youngest older condition control instruction is, itself, conditional. It will be appreciated that if the youngest older condition control instruction is conditional, it may not be the condition control instruction that actually controls how the respective condition of the candidate producer instruction is to be resolved. Hence, if the condition control instruction is conditional, it is determined whether the respective condition has been resolved at step 134. If not, then the process waits until the condition has been resolved at step 136.

If the condition has been resolved as unsatisfied (i.e. condition=false), then the youngest older condition control instruction will not control the condition of the candidate producer instruction. Hence, the process returns to step 124 to identify the next youngest older condition control instruction in the sequence of instructions.

If the youngest older condition control instruction is unconditional (i.e. no at step 132) or the condition has been resolved as satisfied (i.e. condition=true), then the youngest older condition control instruction will control the condition of the candidate producer instruction. Hence, at step 138, the condition resolution delay determination circuitry 62 may determine a number of cycles until that instruction will be completed. This may be determined, for example, based on its position in an execution pipeline. The condition resolution delay is then determined to be that number of cycles at step 140.

As discussed previously, the data production delay (which also contributes to the data availability delay) may be determined based on various factors such as: the instruction type of the candidate producer instruction, the availability of operands for the candidate producer instruction, and a delay for the candidate producer instruction to reach an available execution unit of a type capable of executing the candidate producer instruction. Accordingly, based on the data production delay and the condition resolution delay, the total data availability delay can be computed. It will be appreciated that the data availability delay is not necessarily a sum of the two delays. In some examples, the condition control instruction may be executed at least partially in parallel with the candidate producer instruction, thereby causing the data availability delay to be less than the sum of the two delays. Hence, the precise computation of the data availability delay may dependent on a particular implementation of the execute stage 16.

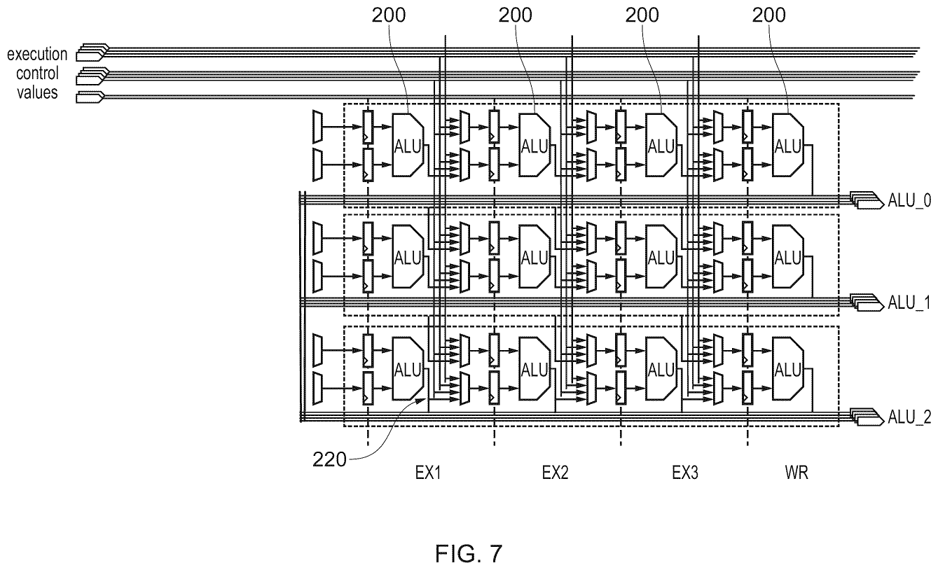

As has been mentioned in previous examples, the execute stage 16 may be arranged in an execution pipeline such that there are a plurality of execute units at different pipeline stages. One example of such an arrangement is shown in FIG. 7, where 12 ALUs 200 are arranged into a superscalar pipeline with three parallel issue slots (ALU_0, ALU_1 and ALU_2) each comprising 4 pipeline stages (EX1, EX2, EX3 and WR).

Bypassing circuitry 220 is also provided with a set of storage elements for storing intermediate results such as source operands for the following pipeline stage or data values produced from the previous pipeline stage. This therefore provides a data path which makes an output of one ALU 200 available as an input to the subsequent ALU 200, thereby bypassing the any requirement to write the result to the register file 14 and then retrieve it for the consumer instruction. Some examples may also include a data path that makes an output of an ALU 200 of a later pipeline stage available as an input to an ALU 200 in an earlier pipeline stage. Accordingly, an instruction that is executed in a later cycle, but at an earlier point in the pipeline can still make use of the data value without having to retrieve the data value from the register file 14.

Additional execution control bits may also be input at various pipeline stages for further controls on how execution is handled. An instruction issued by the issue stage 12 is issued to be executed in a particular pipeline stage, for example in EX2. The instruction information (e.g. an opcode, input operand data, etc) is received at EX1 and then passed to EX2 where the ALU 200 in EX2 then executes the instruction to generate output operands. Those output operands are then passed through EX3 until WR, to generate an output of the execution pipeline to be written back to the register file 14 via the writeback stage 18. By using this arrangement, a consumer instruction may be issued for execution in a later pipeline stage, e.g. EX3, even though the source operands are not available at issue-time. However, the issue stage 12 may expect that the data value used for the source operand will become available by the cycle corresponding to EX3, e.g. due to execution of the actual producer instruction in an earlier pipeline stage, e.g. EX2, producing the data value to be used in EX3. Assuming that the pipeline advances on every cycle, the issue stage 12 can therefore issue a consumer instruction if the data availability delay is 3 cycles, such that it accumulates the necessary data from each pipeline stage as it moves through each stage pipeline stage, until eventually the consumer instruction is executed by the fourth ALU in the pipeline. Accordingly, the issue stage 12 may issue the instructions to be executed sooner or later in the pipeline, while maintaining that instructions are issued in an order in which younger instructions are not permitted to bypass older instructions.

It will be appreciated that the execution pipeline shown in FIG. 7 is just one example, and different examples are also possible. The pipelines may be of a different length with more or fewer pipeline stages, or there may be more or fewer parallel pipelines. The ALUs 200 may also be replaced by a different type of execution unit, such as the floating-point unit 22.

The following is a list of steps that may be performed as part of some examples implementing the present techniques. For issuing a consumer instruction in respect of a single source register:
1. If the current instruction predicate (e.g. condition) resolved to “false”, stop considering older instructions, otherwise continue.
2. Find all older instructions writing to the same register (e.g. the set of candidate producer instructions).
3. Find the youngest member of the set of candidate producer instructions that has its predicate resolved to “true”. Remove all instructions older than (but not including) this instruction from the set of candidate producer instructions.
4. Remove, from the set of candidate producer instructions, all instructions with predicate resolved to false.
5. From the remaining instructions in the set of candidate producer instructions, select the longest number of advances from the number of advances necessary for their predicate to resolve, and/or their data to be available.
6. If there is an execution unit that is available to execute the current instruction at the pipeline depth corresponding to the number of advancements needed from step 5, issue the instruction to execute in that pipeline stage, otherwise stall.

For collecting data as an operation moves down the pipeline:
1. At issue, read the register file, save the data with the instruction.
2. At each pipeline stage, find the youngest producer instruction of the needed data that has its data available and has it's predicate resolved to “true”. If such a producer instruction exists, replace the stored data with the data from that producer instruction.
3. If the instruction reaches the scheduled pipeline stage, and a same cycle bypass exists, and the producer instruction has resolved to “true”, mux the same-cycle bypass to the execution unit, otherwise use the stored data for the source.

If the correct data cannot be presented to the execution unit in the same cycle, then the execution unit at the scheduled pipeline stage can stall to obtain the correct data in the following cycle.

For determining when a predicate will be resolved:
1. Find the youngest older outstanding predicate controlling instruction.
2. If no such instruction exists, predicate is resolved.
3. If such an instruction exists, but does not provide all of the predicate information required, the predicate resolution cannot be predicted while the instruction is outstanding.
4. If such an instruction is itself predicated, and its predicate is not resolved, then the predicate resolution of the instruction under consideration cannot be predicated until the predicate for such a producing instruction is resolved.
5. If neither of steps 3 or 4 occur, then the predicate for the instruction under consideration will be resolved when the instruction found in step 1 has its data available, plus a delay to compare the predicate control to the value needed for the instruction to resolve to true or false.
6. If either of steps 3 or 4 occur, then treat the predicate as if it will resolve at the latest point in the pipeline a predicate can possibly resolve.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

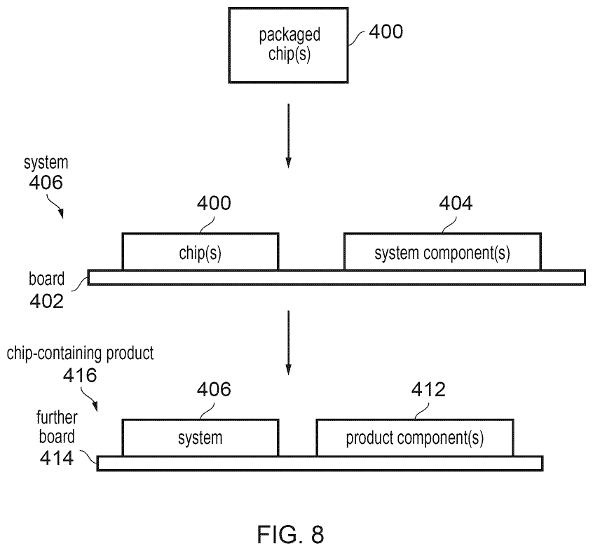

As shown in FIG. 8, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
(1) An apparatus Comprising:
   processing circuitry comprising one or more execution units; and
   issue circuitry configured to issue an instruction to be executed by one of the one of more execution units;
   wherein in response to a consumer instruction identifying a source data operand, the issue circuitry is configured to:
      identify a set of one or more candidate producer instructions for the consumer instruction from a plurality of outstanding instructions that have not yet completed, wherein each candidate producer instruction is capable of producing a data value to be used for the source data operand of the consumer instruction; and
      in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issue the consumer instruction to be executed by one of the one or more execution units.
(2) The apparatus of clause (1), wherein, in the case where the set comprises two or more candidate producer instructions, prior to determining whether the at least one conditional instruction will have a respective condition satisfied, the issue circuitry is configured to issue the consumer instruction to be executed by the one of the one or more execution units.
(3) The apparatus of clause (1) or clause (2), comprising
   tracking circuitry configured to maintain tracking information associated with the plurality of outstanding instructions; and
   for a given outstanding instruction, the tracking circuitry is configured to store an indication of whether the given outstanding instruction is still capable of being the actual producer instruction that will produce the data value to be used for the source data operand of the consumer instruction.
(4) The apparatus of clause (3), wherein the tracking circuitry is configured to set the indication to indicate that the given outstanding instruction is not capable of being the actual producer instruction, in response to the given outstanding instruction specifying a destination register that is different to a source register specified by the consumer instruction.
(5) The apparatus of clause (3) or (4), wherein the tracking circuitry is configured to set the indication that the given outstanding instruction is not capable of being the actual producer instruction, in response to a younger instruction specifying a same destination register as the given outstanding instruction, wherein the younger instruction is an unconditional instruction or is a conditional instruction for which the respective condition is resolved as satisfied.
(6) The apparatus of any of clause (3) to (5), wherein the tracking circuitry is configured to set the indication that the given outstanding instruction is not capable of being the actual producer instruction, in response to the given outstanding instruction being a conditional instruction for which the respective condition is resolved as unsatisfied.
(7) The apparatus of any of clause (3) to (6), wherein the tracking circuitry is configured to store a plurality of instances of the tracking information, wherein each instance of the tracking information is associated with a corresponding register and is indicative of which outstanding instructions are capable of being the actual producer instruction for a consumer instruction specifying that corresponding register as source register.
(8) The apparatus of any of clause (3) to (7), wherein the tracking circuitry is configured to maintain delay tracking information to indicate, for each of the at least one conditional instruction, a number of cycles until the respective condition can be resolved.
(9) The apparatus of any of clause (1) to (8), wherein whether the respective condition is resolved to be satisfied or not satisfied is dependent on a predicate value dependent on data generated by a predicate control instruction.
(10) The apparatus of clause (9), wherein in response to determining that the predicate value is dependent on data generated by two or more predicate control instructions, the issue circuitry is configured to suppress issuing the consumer instruction prior to determining which of the two or more candidate producer instructions is the actual producer instruction.
(11) The apparatus of any preceding clause, comprising:
   delay determination circuitry configured to determine a data availability delay indicative of a largest number of cycles until the data value to be used for the source data operand of the consumer instruction has been produced by each of the set of one or more candidate producer instructions,
   wherein the issue circuitry is configured to issue the consumer instruction to be executed after the data availability delay.
(12) The apparatus of clause (11), wherein
   the delay determination circuitry is configured to determine the data availability delay based on a condition resolution delay and a data production delay, wherein
   the condition resolution delay is a number of cycles until a respective condition of a given candidate producer instruction is resolved; and
   the data production delay is a number of cycles for the one or more execution units to generate the data value in response to executing the given candidate producer instruction.
(13) The apparatus of clause (12), wherein
   the delay determination circuitry is configured to:
      identify a set of condition control instructions, wherein each condition control instruction is capable of producing control data for resolving a respective condition of one of the set of one or more candidate producer instructions;
      determine the condition resolution delay in dependence on a number of cycles until each of the set of condition control instructions will be completed.
(14) The apparatus of any of clauses (11) to (13), wherein in response to the data availability delay being a number of cycles larger than a number of cycles for the consumer instruction to reach any available execution unit of a type capable of executing the consumer instruction, the issue circuitry is configured to stall the consumer instruction.
(15) The apparatus of any preceding clause, wherein each of the set of one or more candidate producer instructions specifies a destination register that is a same register as a source register providing the source data operand of the consumer instruction.
(16) The apparatus of any preceding clause, wherein the processing circuitry comprises a plurality of execution units arranged in a plurality of pipeline stages, wherein
   the plurality of execution units including at least two skewed execution units in different pipeline stages, each skewed execution unit configured to execute a same type of instruction.
(17) The apparatus of any preceding clause, wherein the processing circuitry comprises bypassing circuitry configured to provide a data path to bypass a register file, wherein the data path is configured to make an output of one execution unit available as an input to a subsequent execution unit.
(18) A system comprising:
   the apparatus of any preceding clause, implemented in at least one packaged chip;
   at least one system component; and
   a board,
wherein the at least one packaged chip and the at least one system component are assembled on the board.
(19) A chip-containing product comprising the system of clause (18), wherein the system is assembled on a further board with at least one other product component.
(20) A method comprising:
   issuing an instruction to be executed by one of one or more execution units;
   wherein in response to a consumer instruction identifying a source data operand:
      identifying a set of one or more candidate producer instructions for the consumer instruction from a plurality of outstanding instructions that have not yet completed,
   wherein each candidate producer instruction is capable of producing a data value to be used for the source data operand of the consumer instruction; and
      in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issuing the consumer instruction to be executed by one of the one or more execution units.
(21) A non-transitory computer-readable medium storing computer-readable code for fabrication of an apparatus comprising:
   processing circuitry comprising one or more execution units; and
   issue circuitry configured to issue an instruction to be executed by one of the one of more execution units;
   wherein in response to a consumer instruction identifying a source data operand, the issue circuitry is configured to:
      identify a set of one or more candidate producer instructions for the consumer instruction from a plurality of outstanding instructions that have not yet completed, wherein each candidate producer instruction is capable of producing a data value to be used for the source data operand of the consumer instruction; and
      in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issue the consumer instruction to be executed by one of the one or more execution units.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry comprising one or more execution units; and
issue circuitry configured to issue an instruction to be executed by one of the one of more execution units;
wherein in response to a consumer instruction identifying a source data operand, the issue circuitry is configured to:
identify a set of one or more candidate producer instructions for the consumer instruction from a plurality of outstanding instructions that have not yet completed, wherein each candidate producer instruction is capable of producing a data value to be used for the source data operand of the consumer instruction; and
in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issue the consumer instruction to be executed by one of the one or more execution units.

2. The apparatus of claim 1, wherein, in the case where the set comprises two or more candidate producer instructions, prior to determining whether the at least one conditional instruction will have a respective condition satisfied, the issue circuitry is configured to issue the consumer instruction to be executed by the one of the one or more execution units.

3. The apparatus of claim 1, comprising
tracking circuitry configured to maintain tracking information associated with the plurality of outstanding instructions; and
for a given outstanding instruction, the tracking circuitry is configured to store an indication of whether the given outstanding instruction is still capable of being the actual producer instruction that will produce the data value to be used for the source data operand of the consumer instruction.

4. The apparatus of claim 3, wherein the tracking circuitry is configured to set the indication to indicate that the given outstanding instruction is not capable of being the actual producer instruction, in response to the given outstanding instruction specifying a destination register that is different to a source register specified by the consumer instruction.

5. The apparatus of claim 3, wherein the tracking circuitry is configured to set the indication that the given outstanding instruction is not capable of being the actual producer instruction, in response to a younger instruction specifying a same destination register as the given outstanding instruction, wherein the younger instruction is an unconditional instruction or is a conditional instruction for which the respective condition is resolved as satisfied.

6. The apparatus of any of claims 3, wherein the tracking circuitry is configured to set the indication that the given outstanding instruction is not capable of being the actual producer instruction, in response to the given outstanding instruction being a conditional instruction for which the respective condition is resolved as unsatisfied.

7. The apparatus of claim 3, wherein the tracking circuitry is configured to store a plurality of instances of the tracking information, wherein each instance of the tracking information is associated with a corresponding register and is indicative of which outstanding instructions are capable of being the actual producer instruction for a consumer instruction specifying that corresponding register as source register.

8. The apparatus of claim 3, wherein the tracking circuitry is configured to maintain delay tracking information to indicate, for each of the at least one conditional instruction, a number of cycles until the respective condition can be resolved.

9. The apparatus of claim 1, wherein whether the respective condition is resolved to be satisfied or not satisfied is dependent on a predicate value dependent on data generated by a predicate control instruction.

10. The apparatus of claim 9, wherein in response to determining that the predicate value is dependent on data generated by two or more predicate control instructions, the issue circuitry is configured to suppress issuing the consumer instruction prior to determining which of the two or more candidate producer instructions is the actual producer instruction.

11. The apparatus of claim 1, comprising:
delay determination circuitry configured to determine a data availability delay indicative of a largest number of cycles until the data value to be used for the source data operand of the consumer instruction has been produced by each of the set of one or more candidate producer instructions,
wherein the issue circuitry is configured to issue the consumer instruction to be executed after the data availability delay.

12. The apparatus of claim 11, wherein
the delay determination circuitry is configured to determine the data availability delay based on a condition resolution delay and a data production delay, wherein
the condition resolution delay is a number of cycles until a respective condition of a given candidate producer instruction is resolved; and
the data production delay is a number of cycles for the one or more execution units to generate the data value in response to executing the given candidate producer instruction.

13. The apparatus of claim 12, wherein
the delay determination circuitry is configured to:
identify a set of condition control instructions, wherein each condition control instruction is capable of producing control data for resolving a respective condition of one of the set of one or more candidate producer instructions;
determine the condition resolution delay in dependence on a number of cycles until each of the set of condition control instructions will be completed.

14. The apparatus of claim 11, wherein in response to the data availability delay being a number of cycles larger than a number of cycles for the consumer instruction to reach any available execution unit of a type capable of executing the consumer instruction, the issue circuitry is configured to stall the consumer instruction.

15. The apparatus of claim 1, wherein the processing circuitry comprises a plurality of execution units arranged in a plurality of pipeline stages, wherein
the plurality of execution units including at least two skewed execution units in different pipeline stages, each skewed execution unit configured to execute a same type of instruction.

16. The apparatus of claim 1, wherein the processing circuitry comprises bypassing circuitry configured to provide a data path to bypass a register file, wherein the data path is configured to make an output of one execution unit available as an input to a subsequent execution unit.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
issuing an instruction to be executed by one of one or more execution units;
wherein in response to a consumer instruction identifying a source data operand:
identifying a set of one or more candidate producer instructions for the consumer instruction from a plurality of outstanding instructions that have not yet completed, wherein each candidate producer instruction is capable of producing a data value to be used for the source data operand of the consumer instruction; and
in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issuing the consumer instruction to be executed by one of the one or more execution units.

20. A non-transitory computer-readable medium storing computer-readable code for fabrication of an apparatus comprising:
processing circuitry comprising one or more execution units; and
issue circuitry configured to issue an instruction to be executed by one of the one of more execution units;
wherein in response to a consumer instruction identifying a source data operand, the issue circuitry is configured to:
identify a set of one or more candidate producer instructions for the consumer instruction from a plurality of outstanding instructions that have not yet completed, wherein each candidate producer instruction is capable of producing a data value to be used for the source data operand of the consumer instruction; and
in a case where the set comprises two or more candidate producer instructions of which at least one candidate producer instruction is a conditional instruction to be executed in dependence on a respective condition being satisfied, prior to determining which of the two or more candidate producer instructions is an actual producer instruction that will produce the data value to be used for the source data operand of the consumer instruction, issue the consumer instruction to be executed by one of the one or more execution units.
